(19) United States
(12) Patent Application Publication
(10) Pub. No.: US 2022/0392196 A1
(43) Pub. Date: Dec. 8, 2022

(54) METHOD AND SYSTEM FOR MAPPING AND IDENTIFICATION OF OBJECTS

(71) Applicants: Eija Lehmuskallio, Helsinki (FI); Jouko Lehmuskallio, Helsinki (FI)

(72) Inventor: Eija LEHMUSKALLIO, Helsinki (FI)

(21) Appl. No.: 17/891,227

(22) Filed: Aug. 19, 2022

Related U.S. Application Data
(63) Continuation of application No. PCT/FI2020/050697, filed on Oct. 22, 2020.

(30) Foreign Application Priority Data
Oct. 23, 2019 (FI) 20195907

(51) Int. Cl. G06V 10/764; G06F 16/55

(52) U.S. Cl. CPC G06V 10/764; G06F 16/55

(57) ABSTRACT

The invention is concerned with a method and a system for the identification and mapping of objects on the basis of a picture taken of the object. The objects to be identified and mapped are classified in the database(s) on the basis of their position and/or characteristic(s). A picture that has been taken of an object to be identified is saved in the user device. The position of the object is informed to the service. The method is mainly characterized by the service checking whether there is earlier information of an object from the same position. The service identifies the object on the basis of the picture, the position of the object and, its characteristic(s). In the absence of earlier identification information of an object in the same position, the service marks the location of the object on a map on the basis of the position information.

### TECHNICAL FIELD

The present invention is concerned with a method and system for mapping and identification of objects.

### BACKGROUND

Biodiversity is the variety and variability of life on Earth and can be considered a measure of variation at the genetic, species, and ecosystem level. Biodiversity boosts ecosystem productivity where each species, no matter how small, all have an important role to play and depend on each other for a balanced ecosystem. For example, a larger number of plant species means a greater variety of crops. Greater species diversity ensures natural sustainability for all life forms.

Plants play a key role in maintaining ecological and evolutionary processes as well as human livelihoods. Uncertainties in plant occurrence information remain a central problem in ecology knowledge and should be assessed globally not only because it is of importance as such but since there is an increasing phenomenon of invasive species all over the world due to the climate change. Following occurrence information of animals, insects, and plants also gives information of the climate change itself. An invasive species is a species that is not native to a specific location. It is an introduced species that has a tendency to spread to a degree believed to cause damage to the environment, human economy or human health.

Thus, there are several reasons for studying and mapping occurrence of plants and other species and generally objects in nature and for following changes therein. Scientists are therefore more and more looking at nature to see how various species work together and how they are distributed in the world.

There are numbers of species whose distributions are estimated with hypothetical methods. In many current studies and applications, researchers generally use random methods to simulate the distribution of plants. Even if such random approaches are used as common solutions to study distributions, they might fail to reflect some specific biological aspects among types of plants. Because there is an enormous number of species, information of the distribution of each plant species is therefore difficult to obtain from actual measurement methods.

Moreover, the identification itself of different nature objects is a related issue.

There are methods with which people generally, when e.g. walking in the nature, can identify different objects and phenomena in nature, such as plants, mushrooms, stones, minerals, butterflies, insects, animals and phenomena in the sky.

The identification of objects and phenomena in nature is usually based on knowledge or by using books or sites on the internet for finding the desired information.

Some modern methods are based on applications in a smartphone, with which the objects can be identified on the basis of described or selected characteristics or from a picture by pattern recognition possibly together with GPS-based position information.

U.S. Pat. No. 7,400,295B of the applicants discloses identification of objects by means of a user device on the basis of localization information and one or more characteristics. The object to be identified is localized and the position of the object is informed to an application in a smartphone having a service product to which the user device is connected. The service fetches information on the basis of the position of the object and selected characteristics from a database and presents the information of the plant species or of other objects at the user device.

The international patent application WO2006/120286A2 of the applicants discloses an improved method for the identification of the objects. In this method, a picture is taken of the object. The service product reads the characteristics of the object directly from the picture by means of e.g. pattern recognition on the basis of which the object is identified.

There is, however, a need for a more effective system, which could give more versatile information of objects and species in nature both for private use and for research organizations. People not only need to identify objects in the nature, they also need associated information for example of plants e.g. what becomes to its use as food and related healthy information. Scientists, in turn, need real-time information of ecological systems and environmental phenomena.

### THE OBJECT OF THE INVENTION

The object of the invention is a dynamic and interactive system used as for improving the knowledge of plants and other nature objects and for sharing and following information on their distribution.

### SUMMARY OF THE INVENTION

The method of the invention for the identification and mapping of objects on the basis of a picture taken of the object is performed by means of a user device and a service program product that is connected to one or more databases. The service program product provides a service that is made use of by the user device via a user interface. Objects can be identified and mapped with the service. The objects to be identified and mapped are classified in the database(s) on the basis of their position and/or characteristic(s). The method comprises presenting the service for the user via the user interface on the user device in form of a menu of objects to be identified. A picture that has been taken of an object to be identified is saved in the user device. The position of the object is informed to the service. The method is mainly characterized by the service checking whether there is earlier information of an object from the same position. The service identifies the object on the basis of the picture, the position of the object and, its characteristic(s). In the absence of earlier identification information of an object in the same position, the service marks the location of the object on a map on the basis of the position information. The service then presents the identification information of the object on the user interface together with associated information and a map, wherein the location of the object has been marked.

The system of the invention for the identification and mapping of objects in accordance with the method of the invention comprises a user device, a service program product with a database and a user interface, via which the service program product provides a service that is made use of by the user device. Objects to be identified and mapped are classified in the database on the basis of their position and/or characteristic(s). The user device has means for taking a picture of an object to be identified and for sending it to the service. The service has means to fetch information of the identified object and present the identified object with associated information on the user interface. The service presents a map on the user interface of the service and the object to be identified is placed on the map on a place corresponding to the position of the object localized and identified.

The preferable embodiments of the invention have the characteristics of the sub claims.

The invention is primarily meant for identification of objects in the nature, such as plants, mushrooms, stones, minerals, butterflies, insects, and animals.

As the user already has informed the location of the plant, either by means of the position of the mobile station or by sending the location information manually, the system excludes all plants not being within the region of localization for the identification and which do not exist at that time in the area in question. In this way, the identification is faster and the information that has to be sent over-the-air is less extensive.

In the presence of earlier identification information of the object from the same position, the service might present one or more alternative objects for the user device on the user interface for identification, which correspond to the earlier identifications. It might for example be that there is no other plants or objects of that type in the position in question, whereby the identification is straight forward and the service does not need other information for the identification.

Identification of the Picture of the Object by Artificial Intelligence (AI)

General

The service program product of the service uses Artificial Intelligence (AI) for analyzing the picture of the object or a part thereof in order to identify the object and classify it to a certain type of the object, i.e. to a certain species, e.g. when it is question about plants, insects or animals.

The term Artificial Intelligence (AI) is widely used today as intelligence demonstrated by machines and has no precise definition. Many tools are used in AI for performing the intelligent functions, such as versions of search and mathematical optimization, as well as neural networks, which generally are called Artificial Neural Networks (ANN).

In this invention, Artificial Intelligence (AI) is used for classification of objects in nature in order to be able to identify them with respect to species, type or the like, primarily by ANNs as classification algorithms performing the classification.

The terms “pattern recognition” and “machine learning” are closely related to artificial intelligence, machine learning being a type of pattern recognition, which in turn is an approach to artificial intelligence. In pattern recognition input data is classified into objects or classes based on key features. Image recognition is a type of pattern recognition being the process of identifying and detecting an object or a feature in a digital image or video.

The invention uses pattern recognition or image recognition for the automatic discovery of regularities in the images through the use of classification algorithms, such as neural networks, and with the use of these regularities to take actions for the classification. The classification takes place by classifying an image into a recognized type of object within a category of objects.

So that the service program product of the service could use image recognition or pattern recognition for analyzing the picture in order to identify the object, artificial intelligence technologies of the above mentioned kind called neural networks can be used to automatically identify the objects in the images.

Training

A set of inputs for which the correct outputs are known, is used to train the neural network. The images can be labelled with descriptive tags, e.g. with respect to characteristics of a plant, and name of the plant.

In the invention, the neural network, i.e. an Artificial Neural Network (ANN), has therefore been trained for image recognition or pattern recognition. In a preferable embodiment, the Artificial Neural Network, ANN, is a Convolutional Neural Network (CNN) that has been trained with image recognition or pattern recognition.

In the pattern recognition technology used in the invention, one or more informative features or characteristics of the object in the picture can also be identified and determined as an individual property or characteristic of the object in the picture being observed.

Image segmentation can be used for the image recognition in order to teach the CNN to make use of different parts of the object in the image and classify the object on the basis of characteristic(s) and thereby facilitate the final identification. The CNN can then focus on one part of the image. For example, in a flower image, the stem, the leaves the petals, etc can be separately analysed. There may be several stages of segmentation in which the neural network image recognition algorithm analyzes smaller parts of the images, for example, within the stem, the leaves, petal, etc. The final output is a prediction based on each feature in the image, how likely it is to belong to an individual in an object class or category. Thus, patterns in visual images are learned with deep learning to predict features that make up an image. The main deep learning architecture used in this context is a Convolutional Neural Network (CNN).

The invention includes selecting suitable variables for successfully implementing the image classification. Many potential variables may be used, preferably including, textural or contextual information of characteristics, and ancillary data. In “pattern recognition” a label is assigned to the input image for textual information.

The Convolutional Neural Network (CNN) might also have been trained with position information to be taken into consideration.

A set of training images is prepared for the training and once they have been prepared, an Artificial Neural Network (ANN), such as a Convolutional Neural Network (CNN), is used to process them to be able to make a prediction on new, unknown images and classify them.

An unrestricted number of different pieces to be identified can be added to the training path to the structure for the identification of species. The name and species of the weights file achieved from the training are inserted in a list in an alphabetical order. The classification and/or prediction works with several programs. This requires a sufficient number of pictures of each species to be identified.

Classification

Once a model is trained, it is applied to a new set of images which did not participate in training (a test or validation set), to test its accuracy. After some tuning, the model can be used to classify real-world images.

Finally, the invention uses the classification algorithms to make a decision about the image and classify it into a type of the object, such as a species.

Type of Input Pictures

The neural network is taught to identify species by means of training pictures. There can be separate neural networks for identification of species on the basis of ordinary photographies, macrophotographies and microphotographies.

The database of the invention has usually more than 750 000 images, which is more than enough so that the neural network can learn to identify species. The database of the invention works well already with 30 000 images and even less than that. There are at least 50 images/species, and 100-200 images of the most common species. Test have shown that with this material, a 100% identification accuracy can be achieved.

The database of the invention with an archive of 750 000 pictures has hundreds of species, such as herbaceous plants (including toxic plants, medical plants and potion plants), woody plants, shrub plants, butterflies, moths and hawkmoths, mosquitos, bumblebees, flies, bugs, ants, spiders, beetles, hymenoptera, dragonflies, birds, mammals, fishes, other underwater organism species, grasses, ferns, mushrooms, polypores, stones and minerals, the most common plant diseases of cereals, weeds of cereals, amphibians, snakes, and whole biotopes including species as hundreds of pictures.

In this way, the user gets basic knowledge about what species belong to a given ecosystem and can inform of changes in different places and abnormalities of species.

The picture that is sent to the service product can be taken by a camera in the mobile station. The camera may be of a type enabling photography macrophotography, photomacrography, photomicrography and/or photomicroscopy.

In photography, the terms “micro-” and “macro-” are closely related. Photomicrography requires a microscope and camera while photomacrography requires a camera and special magnifying lenses and/or special attachments. Photomacrography is usually defined as any magnification at the film plane of 1× (life size) and higher.

Macro photography (or photomacrography or macrography, and sometimes macrophotography), is extreme close-up photography, usually of very small subjects and living organisms like insects, in which the size of the subject in the photograph is greater than life size (though macrophotography technically refers to the art of making very large photographs).

Reproduction ratio (or photographic magnification) is the ratio of the size of the image on the image sensor to the actual size of the subject. For example; it the length of a 5 cm object on the image sensor is 1 cm, the reproduction ratio is 1:5 (0.2×). Reproduction ratios much greater than 10:1 are considered to be photomicrography, often achieved with digital microscope (photomicrography should not be confused with microphotography, the art of making very small photographs).

A micrograph or photomicrograph is a photograph or digital image taken through a microscope or similar device to show a magnified image of an object. This is opposed to a macrograph or photomacrograph, an image which is also taken on a microscope but is only slightly magnified, usually less than 10 times.

Micrography is the practice or art of using microscopes to make photographs. A micrograph contains extensive details of microstructure. A wealth of information can be obtained from a simple micrograph like behavior of the material under different conditions, the phases found in the system, failure analysis, grain size estimation, elemental analysis and so on. Micrographs are widely used in all fields of microscopy.

A light micrograph or photomicrograph is a micrograph prepared using an optical microscope, a process referred to as photomicroscopy. At a basic level, photomicroscopy may be performed simply by connecting a camera to a microscope, thereby enabling the user to take photographs at reasonably high magnification.

Microscope pictures and macro photographies are more accurate in identifying an object in showing more details of the parts of the species than ordinary photographies. By means of such detailed images, a more accurate segmentation of images and feature extraction of characteristics can take place.

System Architecture

The service product can be in the user device or the service product is requested from and communicated with a service provider via a public network such as internet. The service provider holds the service product program and a database connected to that.

When the use of the invention takes place via internet, it can be with a wired user device, such as a Personal Computer (PC), lap top or tablet, or with a wireless user device, such as a mobile station or wireless tablet, especially a smart phone and the user device is in connection with the service provider offering said service through internet. The invention is especially meant for use in connection with mobile stations and other wireless terminals as user device.

The user device is preferably a mobile station, whereby the localization of the object to be identified is performed by positioning the mobile station, whereby the information of the position corresponds to the information given by the positioning system in the mobile station. Said information can be notified automatically by the service means e.g. by the Global Positioning System (GPS). The mobile station can be a GSM phone or other wireless terminal that supports GPS. When the service gets the location information by a positioning system in the mobile station, the user does not have to enter the position, instead the service gets the position of the object (which corresponds to the position of the mobile station) directly.

The localization of an object to be identified might also be performed manually so that the user of the mobile station enters the position of the object found to the service product.

The picture to be sent to the service product is most practically taken with the same mobile station as the one with which it is sent to the service product, but it can also be a picture taken with e.g. a separate digital camera or it can be a scanned picture.

The database can consist of local databases for different countries and/or for different regions of countries, an object menu for each local database and submenus on different levels for the object menu. The objects to be identified are classified in the database on the basis of different characteristics in a hierarchic system by means of the submenus. The submenus contain images, text and/or photographs of the objects by pointing out certain characteristics. The characteristics of e.g. plants comprises properties, like colour, size, description of petals and leaves, etc., possibly in different states of their life. The database can be expanded to several types of objects in nature, such as, such as plants, mushrooms, stones, minerals, butterflies, insects, and animals etc. All information can be in one database or separate databases. When everything is put in a in a single database a species taxonomy can be used to separate species by using plant and animal taxonomies.

There is associated information in connections with the objects. Besides the identified species or name of the object and its photograph or image, as well as occurrence information, the associated information, especially when talking about for example plants or mushrooms, consist of nutrition information, its effective components, substances, ingredients or constituents for conducing health, common allergies causing substances, other possible, possible allergic reactions, medical use and information of substances etc. with medical effects, health information, toxicity and combined effects of the substances with other ingredients.

In the preferable embodiments, all data of the objects have been collected in a single database, whereby the basic information and the associated information are available in the invention from the same database.

The invention can, however, also deal with issues for combining data from different data sources if the associating data is spread among many databases.

Combining data from different sources and providing users with a unified view of e.g. objects in nature is challenging because databases are distributed and usually either commercial or scientific. Data collecting is however needed in today's societies with increasing frequency and the need to share existing data is exploding.

The data acquisition and sharing method of the invention can uses analytics involving further artificial intelligence. By teaching such AI to identify what the data represents—through image recognition or natural language processing, they can learn to spot patterns much more quickly and reliably than humans. That AI works by combining the data with fast, iterative processing and intelligent algorithms, allowing the software to learn automatically from patterns or features in the data.

Mapping Occurrence Information

The invention with its database(s) allows tracking the occurrence of individual plants and what species are found in a given geographic area.

The database used in the invention can track locations of individual occurrences and occurrences of types, species etc. It can be used as a platform showing the location of a particular species. For each occurrence, e.g. the scientific name, one or more images, such as a photograph, common name if available, date sighted, and upon request, the name of the user that made the observation can be shown on the user interface of the service product.

When a user starts the identification of the object in the picture taken, the position of the object is automatically placed on the map on the basis of position information of the mobile station if it has not been mapped earlier. The updating of the map thus takes place automatically when an identification request is made except of some exceptions discussed below. In practice, registration is needed in order to have access to the map.

The service product also might have a function, which recognizes when a given species already has been placed on the map. In such a situation, the function does not accept a mapping of a species, since it already has been mapped on a given place.

The mapping is automized in such a way that it restricts observations of the same species in a given environment. Only new species not mapped are placed on the map. Thus, the system lives along with new observations and actions can be started against newly occurred invasive arts, plant diseases and vermins etc.

Information of species disappeared can also be informed to the service and thus they can be removed from the map. Furthermore, information of species that do not exist in the database at all, such as newly discovered species, can be informed to the service and be automatically placed on the map.

Researchers can react on all new information and take necessary actions, such as inform science society and researchers.

In practice, all inserted occurrence information is checked by researches before final acceptance of inserting it for being in the map in order to ensure the reliability of the information. Researchers who has the right to log in to the service and are users at that level can check the authenticity of the newly entered information and then accept or deny the new species information. New species might also be mapped on the map just by inserting by users having the rights thereto.

Some occurrence information can also be kept unavailable for the public or be made to require special access rights or they can be automatically inserted in a separate map with special access rights. This function could e.g. be used when the species in question to be mapped is an endangered or a threatened species, desired not to tempt public to the place. Also, the information of new unknown species is automatically inserted or transferred to a map with special access rights.

The platform considerably hurries up mapping of occurrence information of species since double work is avoided, and all people can participate in the mapping.

The service can also have a function, with which personal occurrence diaries can be kept but which is not commonly available for everyone.

The data base also contains research data and results in connection with each species and all data can be searched and fetched with keywords, scientific terms and names included.

Advantages

The invention provides new and unique tools to be used in identifying the distribution and abundance or loss of selected plants and for identification of those. The unique tool is provided as a service product that simultaneously work for getting and giving information by being a platform-based service in the category of cloud computing services. It provides a platform allowing customers to develop and create the content in it without the complexity of building and maintaining an infrastructure typically associated with developing and launching an app. Thus, the service product of the invention enables user platform interaction between a user and content, services or other users.

The occurrence of different species can be followed in real-time and thus it is possible to react quickly on acute situations in milieus, such as the existence of vermins, plant diseases, hymenopteranses and beetles. Besides information of occurrence of vermins, desertification and for example information of environments, wherein the number of species are diminishing, can be achieved in real-time and reacted to. Actions can be started for e.g. increasing species disappeared and return them to their original environments. Information can also be indirectly achieved form fast changes of terrain, like floods, overflows, and submersions, fallen trees, and other storm and weather or temperature consequences.

The term “vermin” is used to refer to a wide scope of organisms, including rodents, cockroaches, termites, bed bugs, mosquitoes, ferrets, stoats, sables, rats, and occasionally foxes. Vermins are pests or nuisance animals that spread diseases or destroy crops or livestock. Infectious plant diseases are caused by living (biotic) agents, or pathogens. These pathogens can be spread from an infected plant or plant debris to a healthy plant. Microorganisms that cause plant diseases include nematodes, fungi, bacteria, and mycoplasmas. Hymenoptera is a large order of insects, comprising the sawflies, wasps, bees, and ants.

The effect of the climate change can thus be followed in real-time by means of the invention since it affects the distribution of species, which can be followed by the invention.

The platform can be installed to work in the way that a part of the content requires registration and/or licensing. Different research institutes making research in the same fields can register themselves to the service platform and researchers can make use of and share the information therein along with the progression of the information therein. In that way, parallel work can be avoided.

An important object is that all data of a particular species can easily be collected and found in one place bot what comes to occurrence, identification, appearance, use, characteristics, toxicity, health effects, and all research data. This can be achieved with the service product of the invention working as an interactive platform in real-time.

Such data can e.g. include: a) effects of the species when used together with other species, b) effects of the species together with medicines, c) species causing allergic symptoms, d) species for use as food, and e) species with substances for improving health.

The service product of the invention serves the public sector and is at the same time an important part of climate change research.

The service language can be selected among many possibilities and the names of plants, bugs, butterflies etc are preferably also in Latin.

The invention is now described by means of some advantageous embodiments and examples, the details of which the invention is not restricted to.

### FIGURES

FIG. 1 is an architecture view of an environment in which the invention can be implemented

FIG. 2 is a signal diagram of an embodiment of the method of the invention

### DETAILED DESCRIPTION

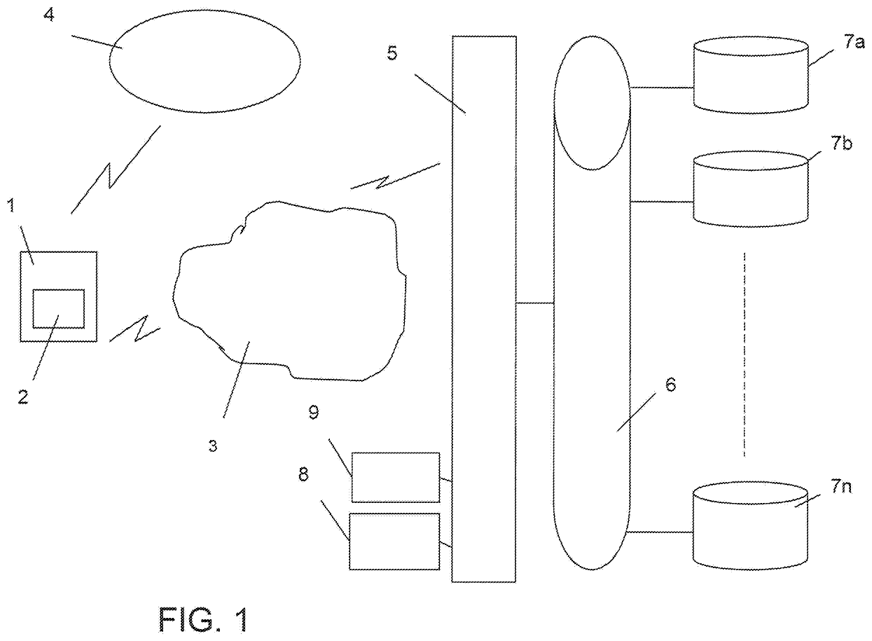

FIG. 1 is an architecture view of an environment in which the invention can be implemented. In this example, the user device is a mobile station 1 having a GPS receiver 2, with which the mobile station can be positioned via a satellite system 4. The mobile station 1 is preferably a GSM phone with access to a public network 3, such as the internet. The mobile station communicates via the public network with a service provider 5 holding a service with a database 6 and a neural network 8 for the identification and a function with a program for mapping the object to be identified. The database in turn is connected to local databases 7a-7n.

The local databases 7a-7n consist of an object menu for each local database and submenus on different levels for the object menu. It is practical to have a local database for each country as well as local databases for different regions in a country. Objects to be identified are classified in the database on the basis of different characteristics in a hierarchic system by means of submenus. The submenus contain images, text or photographs of the objects and the images, text or photographs in the submenus can describe the objects by pointing out certain characteristics.

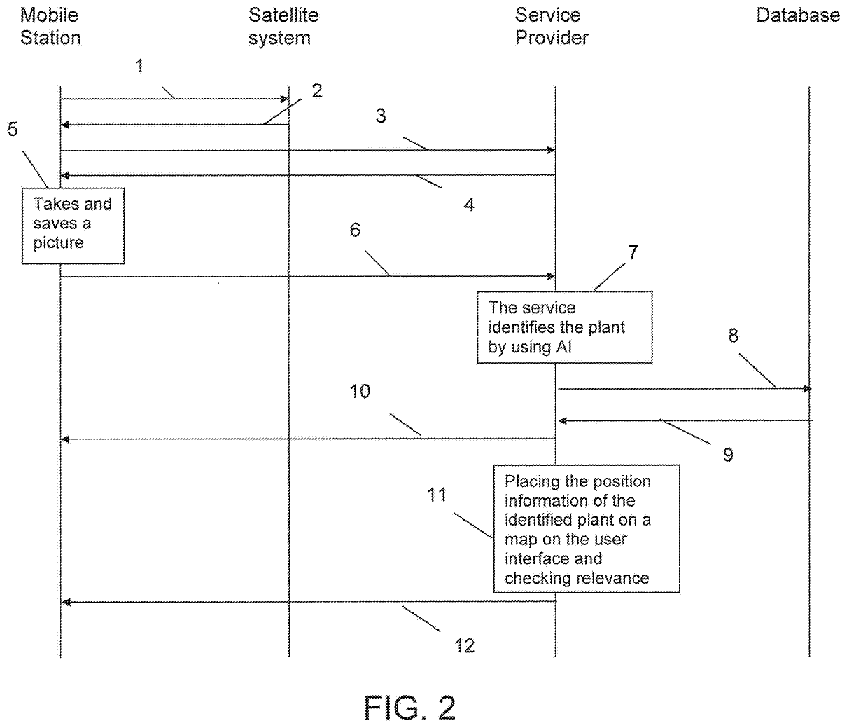

FIG. 2 is a signal diagram of an embodiment of the method of the invention. It is assumed that a user is walking in nature carrying a mobile phone with access to internet. Next, the user finds a plant he does not recognize and therefore would like to identify. As the user has a GPS receiver in the phone, the phone can be positioned by means of signals 1 and 2 through a GPS satellite system.

In signals 3 and 4, the user requests for respective gets a service from the service provider by means of which the plant found can be identified. The GPS information might be forwarded to the service provider in this stage.

First, the service can be presented for the user in form of a menu of alternatives to be identified on a user interface, after which the user has to select whether he wants to identify e.g. a plant, an animal, an insect, or a stone etc. The database can e.g. have a main menu comprising objects to be identified, such as e.g. Plants, Animals, Insects, Stones, etc. according to which the service provider has designed the product.

When the user for instance selects a plant like in this example of FIG. 2, the identification can be based on some of the local databases is based on the position of the plant and maybe on the season.

In an embodiment, wherein the user has a terminal using the GPS system, the service product gets the information directly from the position of the object and therefore sometimes also the type of terrain, where the plant was found or the area, wherein it appears and can make the identification faster by selecting the right local database to match the plant to be identified.

Next, the user takes a picture from the object to be identified with a camera in his mobile station and stores it in step 5.

When the type “plant” has been selected for identification, the information of what is requested goes with signal 6 together with the picture taken to the service provider.

The mobile station sends the picture taken of the object to the service provider together with message 6 or possible as a separate message.

The message, which is sent to the service provider in step 6, can contain the position of the object, as being that of the mobile station from where the signal is sent by signal 6, which position information has been received from a GPS receiver in the telephone. In alternative, said position information is sent to the service in separate messages or even with signal 3. If the telephone does not have any GPS receiver, the user can put in the position manually either by clicking on alternatives presented by the product or by giving coordinates, in which case the manually entered position information is forwarded in signal 6.

The service makes use of Artificial Intelligence AI so that the picture is interpreted in step 7 by an Artificial Neural Network (ANN), preferably by a Convolutional Neural Network (CNN), which is kept by the service product provided by the service provider and which ANN or CNN makes a decision for an analysis of the picture with respect to the identification of the plant presented in the picture and to be identified. The ANN or CNN has earlier been taught by the pictures in the databases so to be able to identify the plant.

In a certain embodiment, the ANN or CNN might be taught to use position information in identifying the plant presented (or generally an object. Thus, it might be taught either to take that information into consideration or not. The service can also make use of the position information.

In some embodiments, the ANN or CNN might be taught to use information of characteristics of the object in identifying the plant presented (or generally an object). Such characteristics can be read from the picture on the basis of the form, the colour and/or the size of the object or be given as data information for the ANN or CNN.

In further embodiments, the identification made by the ANN or CNN can be combined with other methods for the identification for further accuracy, such as those methods described in U.S. Pat. No. 7,400,295 B2 and WO publication 2006/120286 A2 of the applicants.

In U.S. Pat. No. 7,400,295 B2, the object was identified on the basis of characteristics presented by the service program and selected by the user in a way that the service found and fetched an object from the database with objects classified by their characteristics and based on the selected characteristics and optionally also position information.

In WO publication 2006/120286 A2, the object was identified by sending a picture of the object to be identified to the service product, which the service product reads the characteristics of the object on the basis of which the search from the database takes place based on characteristics.

The service program of the service product can fetch content with respect to the identified plant from the correct local database with signals 8 and 9. The content fetched may comprise the name of the plant, a photograph of the plant, a description of characteristics of the plant and associated information such as ingredients, constituents, components, information of use as food or nutrition, medical use, health information, information of possible allergic reactions, and toxicity, etc.

The service then presents the content fetched at a user interface of the service and to be viewed at the mobile station of the user by means of signal 10.

In step 11, the service program checks the relevance of the position information and possible inserts the information on a map.

The service program of the service places the plant on a map on the basis of its position information. The service provides a map service function that shows the occurrence of different plants (an/or other object) found by the users. In this way, user participate in updating the occurrence map kept by the service. Certain users can also directly add plant information on the map.

In practice, the position information is also checked (step not shown) with respect to authenticity in a second check before final acceptance to be placed permanently on the map. The second check might be performed by scientists, researchers, experts or the like.

Either the second check is performed before placing the species info on the map at all or then it is first temporarily there (possible with a message that the information is under check) and first after having been accepted it is permanently there as long as the occurrence is true.

If there is no earlier information on the species in question on the map, and if the second check results in that the position information of the species is relevant for being notified with respect to its occurrence, it is inserted in the map.

If, however, there is earlier information on the species in question on the map, and/or the second check results in that the position information of the species is not correct or not worth being notified with respect to its occurrence, it is not inserted in the map.

A confirmation message telling the results of both checks is optionally sent to the mobile station of the user in step 12.

The steps of FIG. 2 is presented as an example and e.g. the order of the steps can vary.

1.-23. (canceled)

24. Method for identification and mapping of objects on the basis of a picture taken of the object by means of a user device, a service program product that is connected to a database (6) and a user interface, the service program product providing a service that is made use of by the user device via the user interface, with which service objects can be identified and mapped,
the objects to be identified and mapped being classified in the database on the basis of their position and/or characteristic(s), the method comprising:
a) presenting the service for the user via the user interface on the user device in form of a menu of objects to be identified,
b) taking a picture of an object to be identified and saving it in the user device
c) informing the position of the object to the service, and wherein
d) the service checking whether there is earlier information of the object in the same position,
e) the service identifying the object on the basis of the position of the object, its characteristic(s) and/or the picture,
f) in the absence of earlier identification information of the object in the same position, the service marking the location of the object on a map on the user interface on the basis of the position information,
g) the service presenting the identification information of the object on the user interface together with associated information and a map, wherein the location of the object has been marked.

25. The method of claim 24, wherein the presence of earlier identification information of the object from the same position, the service presents one or more alternative identification of the object for the user device corresponding to the earlier identifications.

26. The method of claim 24, wherein the service program product of the service using an Artificial Neural Network, ANN, for analyzing the picture in order to identify the object.

27. The method of claim 26, wherein the Artificial Neural Network, ANN, has been trained with pattern recognition or image recognition.

28. The method of claim 27, wherein the Artificial Neural Network, ANN, is a Convolutional Neural Network, CNN, that has been trained with image segmentation for the image recognition in order to teach the CNN to make use of different parts of the object in the image and classify the object on the basis of characteristic(s) and thereby facilitate the final identification.

29. The method of claim 27, wherein the Artificial Neural Network, ANN, is a Convolutional Neural Network, CNN, that has been trained with position information to be taken into consideration.

30. The method of claim 24, wherein said user device is a mobile station, whereby the localization of an object to be identified is performed by positioning the mobile station, the position information corresponding to the information given by a positioning system in the mobile station.

31. The method of claim 24, wherein the localization of an object to be identified is performed by manually informing the position of the object found to the service product.

32. The method of claim 24, wherein the picture sent to the service product is taken by a camera in the mobile station.

33. The method of claim 24, wherein the picture is taken by photography macrophotography, photomacrography, photomicrography and/or microphotography.

34. The method of claim 24, wherein the service product is in the user device.

35. The method of claim 24, wherein the user device communicates via a public network with the service provider holding the service program with the database, and the service product is requested from the service provider via the public network such as internet.

36. System for the identification and mapping of objects on the basis of its position and a picture of the object, which comprises a user device, a service program product with a database and a user interface, via which the service program product provides a service that is made use of by the user device, with which service objects can be identified and mapped, the objects to be identified being classified in the database on the basis of their position and/or characteristic(s),
the user device having means for taking a picture of an object to be identified and for sending it to the service product, and
wherein
the service product having means to fetch information of the identified object from the database and present the identified object with associated information on the user interface, and
the service product presenting a map on the user interface of the service and the object to be identified is placed or to be placed on the map on a place corresponding to the position of the object localized and identified.

37. The system of claim 36, wherein the service product includes at least one Artificial Neural Network, ANN, for analyzing the picture for the identification, the neural network preferably being a Convolutional Neural network, CNN.

38. The system of claim 36, wherein the user device is a mobile station and further comprises a positioning system, such as the Global Positioning Service (GPS).

39. The system of claim 36, wherein the service product is in the user device.

40. The system of claim 36, wherein the system further comprises a service provider providing the service product.

41. The system of claim 41, wherein the user device is in connection with the service provider through the Internet.

42. The system of claim 36, wherein the database consists of local databases for different countries and/or for different regions of countries, an object menu for each local database and submenus on different levels for the object menu, whereby the objects to be identified are classified in the database on the basis of different characteristics in a hierarchic system by means of the submenus.

43. The system of claim 42, wherein the submenus contains images, text and/or photographs of the objects.

44. The system of claim 42, wherein each object menu comprises different object, such as plants, mushrooms, stones, minerals, butterflies, insects, and animals.

45. The system of claim 36, wherein the associated information, in connections with plants or mushrooms, consists of an identified name of the object, such as occurrence information, nutrition information, effective substances for conducing health, common allergies causing substances, substances with medical effects, and combined effects of the substances with other ingredients.

46. The system of claim 36, wherein the means for taking a picture of an object to be identified is a camera in the mobile station enabling photography, macrophotography and/or microphotography.
